(19) United States
(12) Patent Application Publication
(10) Pub. No.: US 2023/0348229 A1
(43) Pub. Date: Nov. 2, 2023

(54) SOLUTION FOR MONITORING AN ORIENTATION OF AN ELEVATOR CAR

(71) Applicant: KONE Corporation, Helsinki (FI)

(72) Inventors: Matti LAAKSO, Helsinki (FI); Matti MUSTONEN, Helsinki (FI)

(73) Assignee: KONE Corporation, Helsinki (FI)

(21) Appl. No.: 18/217,665

(22) Filed: Jul. 3, 2023

Related U.S. Application Data
(63) Continuation of application No. PCT/EP2021/051460, filed on Jan. 22, 2021.

(51) Int. Cl. B66B 5/00; B66B 5/02

(52) U.S. Cl. CPC B66B 5/0031; B66B 5/02

(57) ABSTRACT

A method for evaluating an orientation of an elevator car, performed by a control unit, includes obtaining measurement data from at least one inclination sensor associated to the elevator car, the measurement data including data values indicative of an orientation of the elevator car; comparing the data values of the measurement data to reference data values; setting, in accordance with a comparison between the data values of the measurement data to the reference data values, a detection result to express one of the following: i) the orientation of the elevator car is proper, ii) the orientation of the elevator car is improper. An arrangement, an elevator system, and a computer program product are also disclosed.

### TECHNICAL FIELD

The invention concerns in general the technical field of elevators. More particularly, the invention concerns monitoring solutions.

### BACKGROUND

Elevator systems are equipped with a plurality of monitoring solutions for maintaining and improving safety in using elevators, but also for controlling an operation of the elevator system. One area of interest in the monitoring is a load in an elevator car. The load information may e.g. be needed for controlling an electrical motor providing power for moving the elevator car in a shaft, but also to control if a safe use of the elevator system is even possible with the load in the elevator car. For example, if the load exceeds a predefined limit, a travel of the elevator car may be prevented for safety reasons.

There is introduced a plurality of methods to obtain information for generating an estimation on the load of the elevator car. The methods are based on using a sensor for generating a measurement data indicative of the load in the elevator car. For example, a load weighing device may comprise an inductive proximity sensor mounted in a middle under a floor of the elevator car between the elevator car and a sling the elevator car resides. Since the elevator car is isolated with springs from the sling any change in the load in the elevator car may be detected from the measurement data obtained from the inductive proximity sensor since the distance of the floor from the sensor changes in accordance with the load in the elevator car. Another example solution according to a prior art for generating an estimation of the load in the elevator car may be based on using strain gauges to generate data representing an elongation of a suspension rope. In other words, the stain gauges mounted on the suspension rope may provide data wherein the elongation of the rope in accordance with the load in the elevator car is used for determining the estimation on the load. Some further solutions may be e.g. be based on generating estimations of the load based on a torque needed for moving the elevator car or even estimating the load by monitoring a number of persons entering and exiting the elevator car and so on.

None of the known methods for evaluating the load of the elevator cars are able to detect if the load is evenly distributed inside the elevator car or not. An uneven distribution of the load in the elevator car, such as piling a heavy load in a corner of the elevator car, may cause problems because it may cause tilting of the elevator car and due to this the elevator car may even hit some components in an elevator shaft due to misalignment, such as landing door couplers. Moreover, the uneven distribution of the load

Hence, there is a need to introduce novel approaches for monitoring of a load in the elevator car.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, an arrangement, an elevator system, and a computer program product for evaluating an orientation of an elevator car.

The objects of the invention are reached by a method, an arrangement, an elevator system, and a computer program product as defined by the respective independent claims.

According to a first aspect, a method for evaluating an orientation of an elevator car is provided, the method, performed by a control unit, comprises: obtaining measurement data from at least one inclination sensor associated to the elevator car, the measurement data comprising data values indicative of an orientation of the elevator car; comparing the data values of the measurement data to reference data values; setting, in accordance with a comparison between the data values of the measurement data to the reference data values, a detection result to express one of the following: i) the orientation of the elevator car is proper, ii) the orientation of the elevator car is improper.

For example, the reference data values may be generated by one of: obtaining the measurement data from the at least one inclination sensor in response to a detection that the elevator car is empty and an indication of an allowable take-off of the elevator car is generated; obtaining the measurement data from the at least one inclination sensor in response to a detection that the elevator car is empty and the elevator car travels at a constant speed; computationally.

The reference data values may also be defined in accordance with a temperature in an operation environment of the at least one inclination sensor.

This may e.g. be done by: obtaining data indicative of an operating temperature of the accelerometer; generating an inquiry to data storage for obtaining the reference data values corresponding to the operating temperature of the inclination sensor, the inquiry comprising data indicative of the operating temperature of the inclination sensor; applying the inquired reference data values in the comparison.

Furthermore, the comparison may comprise: detecting if at least one data value of the measurement data deviates from a respective reference data value over a predefined limit.

The measurement data may e.g. be obtained from the at least one inclination sensor at least at one of the following instants of time: an indication of an allowable take-off of the elevator car is generated; a detection of a constant speed of the elevator car is generated.

The method may further comprise, in response to setting of the detection result to correspond that the orientation of the elevator car is improper generating a control signal to cause at least one of the following: outputting an indication; a prevention of a travel of the elevator car; a braking of a motion of the elevator car; a generation of a request to re-distribute a load in the elevator car; a generation an alarm signal to a pre-defined destination.

The inclination sensor may be an accelerometer.

According to a second aspect, an arrangement for evaluating an orientation of an elevator car is provided, the arrangement comprising: at least one inclination sensor associable to the elevator car of an elevator system, and a control unit configured to: obtain measurement data from the at least one inclination sensor associated to the elevator car, the measurement data comprising data values indicative of an orientation of the elevator car; compare the data values of the measurement data to reference data values; set, in accordance with a comparison between the data values of the measurement data to the reference data values, a detection result to express one of the following: i) the orientation of the elevator car is proper, ii) the orientation of the elevator car is improper.

For example, the control unit of the arrangement may be arranged to generate the reference data values by one of: obtaining the measurement data from the at least one inclination sensor in response to a detection that the elevator car is empty and an indication of an allowable take-off of the elevator car is generated; obtaining the measurement data from the at least one inclination sensor in response to a detection that the elevator car is empty and the elevator car travels at a constant speed; computationally.

The control unit of the arrangement may also be arranged to define the reference data values in accordance with a temperature in an operation environment of the at least one inclination sensor accelerometer. This may e.g. be done by arranging the control unit of the arrangement to: obtain data indicative of an operating temperature of the accelerometer, generate an inquiry to data storage for obtaining the reference data values corresponding to the operating temperature of the inclination sensor, the inquiry comprising data indicative of the operating temperature of the inclination sensor; apply the inquired reference data values in the comparison.

Furthermore, the control unit of the arrangement may be configured to perform the comparison by: detecting if at least one data value of the measurement data deviates from a respective reference data value over a predefined limit.

The control unit of the arrangement may e.g. be configured to obtain the measurement data from the at least one inclination sensor at least at one of the following instants of time: an indication of an allowable take-off of the elevator car is generated; a detection of a constant speed of the elevator car is generated.

Still further, the control unit of the arrangement may further be configured to, in response to setting of the detection result to correspond that the orientation of the elevator car is improper, generate a control signal to cause at least one of the following: outputting an indication; a prevention of a travel of the elevator car; a braking of a motion of the elevator car; a generation of a request to re-distribute a load in the elevator car; a generation an alarm signal to a pre-defined destination.

The inclination sensor may be an accelerometer.

The arrangement may e.g. be implemented as an apparatus comprising the control unit and the at least one inclination sensor.

According to third aspect, an elevator system is provided, the elevator system comprising: an elevator car, and an arrangement according to the second aspect as defined above.

According to a fourth aspect, a computer program product for evaluating an orientation of an elevator car is provided, which computer program product, when executed by at least one processor, cause a control unit to perform the method according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features.

The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically an elevator system according to an example.

FIG. 2 illustrates schematically a method according to an example.

FIG. 3 illustrates schematically an arrangement according to an example.

### DESCRIPTION OF THE EXEMPLIFYING EMBODIMENTS

The specific examples provided in the description given below should not be construed as limiting the scope and/or the applicability of the appended claims.

Lists and groups of examples provided in the description given below are not exhaustive unless otherwise explicitly stated.

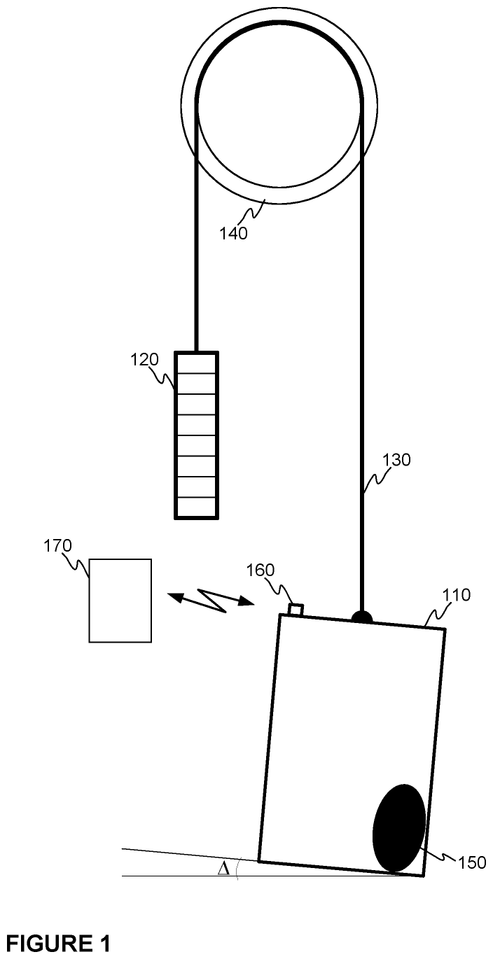

FIG. 1 illustrates schematically an example of an elevator system into which a solution according to the present invention may be implemented to. The elevator system shown in FIG. 1 is based on a counter-weight solution and the figure illustrates only some components of the elevator system which may be necessary for understanding at least some aspects of the invention. The elevator system of FIG. 1 comprises an elevator car 110 which is connected to the counter-weight 120 with an elevator rope 130, such as with a suspension rope or with a belt. The elevator rope 130 is arranged to run over a pulley called as a traction sheave 140. The traction sheave 140 is arranged to rotate around its axis under a control of an electric motor so as to cause a vertical motion of the elevator car 110 in the elevator shaft wherein the rotating force of the traction sheave 140 is transferred to the elevator car 110 with the elevator rope 130.

In order to describe at least some further aspects in relation to the present invention it is hereby assumed that the elevator car 110 may be oriented in a tilted position. The tilted position may be a consequence of some unexpected event e.g. due to maloperation of the elevator system or loading of the elevator car in a non-optimal manner. In FIG. 1 it is schematically illustrated that the elevator car 110 is loaded in inappropriate way i.e. the load 150 is positioned in a coiner of the elevator car 110. An example of another situation causing the misalignment of the elevator car 110 may be that the fixing of the elevator car 110 has failed for any reason and as a result the elevator car 110 ends up to the tilted position. In FIG. 1 a tilting angle of the elevator car 110 is indicated with A (delta). Such situations, and especially the situation originating from the misloading of the elevator car 110, may occur when the elevator system is used for transporting goods from one floor to another. Such a situation may e.g. be in a construction or in a renovation phase of a building the elevator system is arranged to operate.

In accordance with an example the elevator system is equipped with an arrangement by means of which it is possible to detect a misalignment of the elevator car 110 in an efficient way which is also cost-effective. Namely, the elevator system, and especially the elevator car 110, may be equipped at least with at least one inclination sensor 160 suitable for generating measurement data by means of which it is possible to generate data indicative of an orientation of the elevator car 110. In accordance with the present invention the sensor 160 applicable for generating the measurement data may be an accelerometer which is referred with the reference number 160 from here on and used as a non-limiting example of the applicable inclination sensor. The sensor arrangement be such that it is able to generate measurement data from which the orientation of the elevator car 110 in desired directions, such as in one or more, may be evaluated. For example, an orientation of the elevator car 100 in a three dimensional (3D) space i.e. in three directions referred with X, Y, Z, may be under interest. Thus, the sensor arrangement may comprise only one inclination sensor, such as an accelerometer, 160 if it is configured to generate the orientation data in 3D space or a plurality of inclination sensors, such as accelerometers 160, such as three, each configured to generate measurement data in one direction being different to each other in order to generate the orientation based on the measurement data received from the plurality of accelerometers 160. Hence, the terms inclination sensor 160 shall be understood to cover any sensor implementation from which it is possible to obtain data by means of which it is possible to generate information on an orientation of the elevator car 110 into which the accelerometer 160 is associated to. The association of the accelerometer 160 to the elevator car 110 is advantageously arranged so that the accelerometer 160 is fixed, e.g. permanently or detachably, to a structure of the elevator car 110 so that measurement data for evaluating the orientation of the elevator car 110 is received in an optimal manner. For example, the accelerometer 160 may be positioned by mounting it on an exterior surface of the elevator car 110, such as on a roof or bottom of the elevator car 110.

For sake of completeness an example of an applicable accelerometer 160 for implementing the present invention may be so-called three-axis accelerometer which may be configured to be sensible to both a linear acceleration and a local gravitational field. Specifically, for the purpose of the present invention especially the gravitational field is in an outmost interest, and in an absence of the linear acceleration, the output of the accelerometer 160 represents a measurement of a rotated gravitational field vector in which the accelerometer pitch, roll, and yaw orientation angels are obtained, and linked to the coordinates in X, Y, Z coordinate system wherein the elevator car 110 resides. As a result, data representing an orientation of the elevator car 110 may be generated on the basis of the gravitational field vectors. In general, an applicable sensor may be any inclination sensor from which such measurement data may be obtained.

Still further, the elevator system may comprise a control unit 170 configured to obtain the measurement data from the accelerometer 160 and perform processing of data so as to generate an estimation of the orientation of the elevator car 110. The control unit 170 may be communicatively connected to the accelerometer 160 either by applying wireless communication techniques or wired communication techniques, or even both. In accordance with some examples, the control unit 170 resides distantly to the building where the rest of the elevator system resides, such as in a data center configured to monitor one or more elevator systems. Alternatively or in addition, the control unit 170 may reside on the site of the elevator system, such as being a controller of the elevator system, or even it may be associated to the sensor 160 so that the sensor 160 and the control unit 170 form an apparatus associated to the elevator car 110.

In the forthcoming description aspects in relation to an evaluation of an orientation of the elevator car 110 are provided. The evaluation of the orientation of the elevator car 110 may be based on a comparison of a measurement data obtained from the accelerometer 160 to reference data. The reference data comprises data values which may be used for comparing respective measurement data values to them in order to generate information on the orientation of the elevator car 110. In accordance with some example embodiments the reference data may be generated when a maintenance operation of the elevator system, and especially of the elevator car 110, is performed. For example, at that operation the elevator car 110 may be arranged to lie freely, such as hanging empty (i.e. no load inside the elevator car) in an unsupported manner on an elevator rope 130, so that its orientation fulfils technical requirements set for the elevator system. Such an orientation may be called as nominal orientation of the elevator car 110. By measuring the output of the at least one accelerator 160 it is possible to obtain reference data and store it e.g. in a memory accessible to the control unit 170. Another aspect is that the accelerometers 160 have by nature an inherent bias which at least shall be made available through the generation of the reference data e.g. in the described manner. Besides, by generating the reference data in the manner as described any misalignment in an installation of the sensor may be ignored as the generated reference data also includes it. Another way to generate reference data may be such that the elevator car 110 being empty is caused to travel at constant speed in its path when it is known that the orientation of the elevator car 110 is acceptable. Since the elevator car 110 is in the constant motion, the accelerometer 160 measures only gravitational components experienced by the elevator car 110, and, hence, the measured data may be used as a reference data for latter measurements. Moreover, in some implementations the reference data may be generated in accordance with a temperature. In other words, the reference data may be generated as data sets, in any of the described manner, wherein data set is defined for a plurality of operating temperatures of the elevator system. This kind of approach is advantageous because the inherent bias of the accelerometer 160 is affected by the temperature of the accelerometer 160 which follows the temperature of the environment which is referred here with the operating temperature. Hence, the reference data may be generated in a plurality of operating temperatures and labeled accordingly so as to allow of a retrieval of the reference data in accordance with the temperature from data storage arranged to store it. For sake of completeness, it is worthwhile to mention that the above described ways to generate the reference data is a non-limiting example and other methods may also be applied to. For example, it may be possible to combine information obtainable from a technical specification of the accelerometer 160 disclosing e.g. bias information in different temperatures with information defining an orientation of the accelerometer 160 in a nominal orientation of the elevator car 110 if the information is obtained by using some other meters.

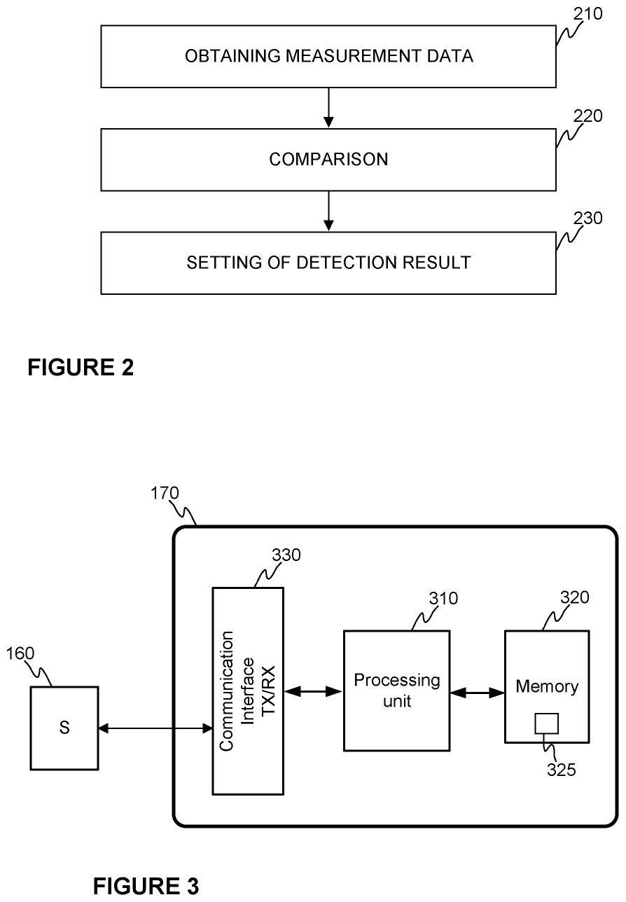

Reverting back to the solution for evaluating of the orientation of the elevator car 110 it is hereby referred to FIG. 2 schematically illustrating an example of a method for performing the evaluation. The method is schematically illustrated in FIG. 2 from a perspective of an entity configured to execute the method, which hereby corresponds to the control unit 170 as mentioned earlier. First, the control unit 170 is configured to obtain 210 measurement data from at least one accelerometer 160 associated to the elevator car 110. As already discussed, the measurement data may comprise data values indicative of an orientation of the elevator car 110 at an instant of the measurement. For example, the data values may be the output of the accelerometer 160 which express the orientation in the coordinate system applied to, such as in coordinates in X, Y, Z axis. The obtainment of the data is advantageously performed at predefined instants of time, i.e. at predefined operational states of the elevator system, at which it is possible to obtain proper measurement data for evaluating the orientation of the elevator car 110. In accordance with some examples, this may at least refer to a situation that the elevator car 110 is not in an accelerating or a decelerating motion. Such a situation may e.g. be that the elevator car 110 is ready to initiate its travel, which may e.g. be detected from an indication of an allowable take-off of the elevator car. Such an indication may e.g. be received from a safety chain of the elevator system corresponding to a situation that the safety chain is closed i.e. the operation of the elevator system is allowed. Another situation for obtaining the measurement data may be when the elevator car 110 travels at a constant speed on its path. This is detectable from the measurement data obtained from the accelerator 160 by detecting that the measurement data values do not change, or are at least within a predefined range, over a predefined time window. Alternatively or in addition, the instant of time may be detected on a basis of data received from other sub-systems of the elevator system, such as from a drive of an electrical motor or from other sensors.

The obtainment of the measurement data from the at least one sensor shall be understood to cover at least the following options: the control unit 170 requests the measurement data from the at least one accelerator 160 at the desired instant of time, e.g. triggered in response to a detection of one of the above mentioned states of the elevator system; the control unit 170 receives the measurement data from the at least one accelerator 160 e.g. continuously or temporarily. In the latter case the measurement data values may be labeled so that it is possible to determine those data values which may be used in the comparison. The labeling may e.g. refer to arranging time stamps to the measurement data values so as to allow finding those measurement values which correspond to instants of time of the predefined states of the elevator system which are selected as states of interest from the determination of the orientation of the elevator car 110 point of view. Any other applicable method for defining the measurement data values for the comparison may be used to.

In response to the obtainment, such as determining, of the measurement data values they are compared 220 to respective reference data values. Through the comparison it may be detected if the data values of the measurement data deviate from the respective reference data values or not. The comparison may e.g. be performed separately in each direction, cf. X, Y, Z directions, for which directions direction-specific reference data values are defined. The reference data values may be the same for each direction or differ from each other. In the comparison 220 it may be detected if at least one data value of the measurement data deviates from a respective reference data value over a predefined limit. The predefined limit may correspond to an acceptable tilting of the elevator car 110 e.g. determined based on a technical implementation of the elevator system and being expressed as percentages, for example. According to an example, the predefined limit is the same for every direction, i.e. for each measurement data value. According to another example, the predefined limits may be defined individually for each direction, i.e. for each measurement data value. The implementation according to the latter example may serve at least some implementations of the elevator system in which tilting to certain directions may be more acceptable than to some other directions at least temporarily. For example, the tilting of the elevator car 110 towards a direction facing a landing door may be defined to be unallowable to the same extent as to other direction, because the tolerances between the elevator car door and the landing door are typically very strict, and the mentioned entities may hit (e.g. (e.g. a door coupler hitting landing doors causing safety chain to open) to each other with rather small tilting.

Finally, in accordance with a comparison between the data values of the measurement data to the reference data values, a detection result may be set 230 to express one of the following: i) the orientation of the elevator car 110 is proper, ii) the orientation of the elevator car 110 is improper. For sake of clarity the setting may be implementing so that if the deviation of the at least one data value of the measurement data exceeds the respective reference data value over the predefined limit the detection result may be generated to indicate that the orientation of the elevator car 110 is improper. Correspondingly, if the predefined limit is not exceeded, the detection result may be set to indicate that the orientation of the elevator car 110 is proper.

The control unit 170 may further be configured to perform in a predefined manner in accordance with the detection result. For example, the control unit 170 may be configured to, in response to a set of the detection result to correspond that the orientation of the elevator car 110 is improper, generate a control signal to cause at least one of the following: output an indication; a prevention of a travel of the elevator car; a braking of a motion of the elevator car; a generation of a request to re-distribute a load in the elevator car, or to generate an alarm signal to a selected destination, such as to a data center. The output of the indication may e.g. refer to an implementation that the control unit 170 is configured to generate a control signal to an output device, such as to a loudspeaker and/or to a display to output an indication that the orientation is not optimal. This kind of approach is advantageous especially in an implementation in which the control unit resides in the elevator car 110 as a monitoring apparatus. Any other output solution may also be applied to in order to provide the indication. On the other hand, the control unit 170 may also be configured to generate a control signal preventing the travel of the elevator car 110. The control unit 170 may be configured to generate such a signal e.g. to an elevator controller if they are separate entities to each other. Alternatively or in addition, the control unit 170 may be coupled to a safety chain of the elevator system, and in response to the detection result indicating that the orientation of the elevator car 110 is improper, the safety chain is opened and the travel of the elevator car 110 is prevented. In case the detection result to indicate the improper orientation is set based on measurement data received during a motion of the elevator car 110, as described, the control unit 170 may be configured to generate a control signal causing a braking of the motion of the elevator car 110. The braking may be implemented so that the elevator car 110 is stopped at the next landing e.g. also taking into account a maximum deceleration limit. In this manner damages to the elevator system may be minimized. Still further, if the misorientation of the elevator car 110 is detected before the elevator car 110 is traveling, the control unit 170 may be configured to generate a request to re-distribute a load in the elevator car 110. This kind of approach may e.g. be implemented if the control unit 110 is aware of that the elevator car 110 is loaded with goods or even with passengers, but they reside at a wrong position in the elevator car 110. The request may e.g. be output with any output means, such as with a loudspeaker or a display, implemented in the elevator car 110. In some example embodiments the control unit 170 may be configured to perform a plurality of operations as described above. For example, the control unit 170 may be configured to both output an indication and prevent a travel of the elevator car 110, or to combine them in any other applicable manner.

Still further, in some example embodiments the control unit 170 may be configured to access information descriptive of an operating temperature of the at least one accelerator 160 of the elevator system. The information may e.g. be received from a temperature sensor positioned in a vicinity of the accelerometer 160, such as associated to the accelerometer 160 or positioned in an elevator shaft of the elevator system. On the basis of the information of the operating temperature the control unit 170 may be configured to define the reference data values for the comparison. For example, the control unit 170 may be configured to inquire the applicable reference data values from data storage by including the temperature information as a parameter in the inquiry. In response to a receipt of the reference data values applicable in the operating temperature in question, the control unit 170 may perform the comparison e.g. through an execution of a computer program code programmed to perform the comparison.

An arrangement configured to generate a detection result indicative of an orientation of an elevator car 110 may comprise a control unit 170 and at least one accelerator 160. The arrangement may be implemented so that the control unit 170 and the sensor 160 are separate entities communicatively connected to each other or they may be arranged in the same apparatus. FIG. 3 illustrates schematically a non-limiting example of the arrangement. The control unit 170 suitable for performing at least part of the method as described may refer to an apparatus being a computing device, such as a server device, or any similar data processing device. For sake of clarity, it is worthwhile to mention that the block diagram of FIG. 3 depicts some components of an entity that may be employed to implement an operation of the control unit 170. The apparatus comprises a processor 310 and a memory 320. The memory 320 may store data, such as comparison data, and computer program code 325. The apparatus may further comprise communication means 330 for wired and/or wireless communication with other entities, such as with at least one accelerometer 170. Furthermore, I/O (input/output) components may be arranged, together with the processor 310 and a portion of the computer program code 325, to provide a user interface for receiving input from a user, such as from a technician, and/or providing output to the user of the apparatus when necessary. In particular, the user I/O components may include user input means, such as one or more keys or buttons, a keyboard, a touchscreen, or a touchpad, etc. The user I/O components may include output means, such as a loudspeaker, a display, or a touchscreen. The output means may be selected in accordance with the methods through which the apparatus may provide output e.g. in relation to an orientation of the elevator car 110 as described in the foregoing description. The components of the apparatus may be communicatively coupled to each other via data bus that enables transfer of data and control information between the components.

The memory 320 and a portion of the computer program code 325 stored therein may further be arranged, with the processor 310, to cause the apparatus, i.e. the device, to perform at least a portion of the method as described in the foregoing description. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some or all of which may be integrated/removable and/or may provide permanent/semi-permanent/dynamic/cached storage.

The computer program code 325 may comprise computer-executable instructions that implement functions that correspond to steps of the method when loaded into the processor 310. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus to perform the method be described herein. Hence, the apparatus may comprise at least one processor 310 and at least one memory 320 including the computer program code 325 for one or more programs, the at least one memory 320 and the computer program code 325 configured to, with the at least one processor 310, cause the apparatus to perform the method as described.

The computer program code 325 may be provided e.g. a computer program product comprising at least one computer-readable non-transitory medium having the computer program code 325 stored thereon, which computer program code 325, when executed by the processor 310 causes the apparatus to perform the method. The computer-readable non-transitory medium may comprise a memory device or a record medium such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for causing an execution of the method in the manner as described in the description herein.

Any of the programmed functions mentioned may also be performed in firm-ware or hardware adapted to or programmed to perform the necessary tasks.

As mentioned, the entity performing the method may also be implemented with a plurality of apparatuses, such as the one schematically illustrated in FIG. 3, as a distributed computing environment. For example, one of the apparatuses may be communicatively connected to a number of sensors 160 and, hence, obtain the measurement data from the sensors 160. Subsequently, the apparatus may be arranged to communicate with other apparat-uses, and e.g. share the measurement data to cause another apparatus to perform at least one portion of the method. As a result, the method performed in the shared computing environment generates the detection result as described.

Still further, the apparatus, i.e. the control unit 170, may be communicatively connected through the communication interface 330 with other entities, such as a controller of the elevator system, and/or any entities of the elevator system. Such entities may e.g. be I/O means of the elevator car 110, such as a display or a loudspeaker therein, for outputting information descriptive of an outcome of the evaluation of the orientation of the elevator car 110.

Some aspects of the invention relate to an elevator system comprising the described arrangement for evaluating an orientation of an elevator car 110 in the manner as described.

For sake of clarity it is worthwhile to mention that the present invention may also be applied in a context of other type of elevator systems than the one based on counter-weight. The arrangement may be associated in the described manner to any elevator car 110 in order to generate data for evaluating the orientation of the elevator car 110 in the described manner.

For sake of completeness, it is worthwhile to mention that even if the description provided in the foregoing description is based on accelerometers as the inclination sensors 160, any other sensor types providing measurement data from which the information representing the orientation of the elevator car 110 may be derived. In accordance with the present invention the gravity components experienced in the measured directions are advantageously measured with the sensor in use. Accelerators are especially suitable for the task due to their accuracy and cheap prize not to forget their integration in many electronic circuit boards nowadays.

As mentioned, the present invention improves a safety of the elevator system as well as prevents damaging of the elevator system since the tilting of the elevator car may be detected in an efficient manner, and, hence, hitting of parts of the elevator system together may be prevented at least to some extent. Also, the present invention may enable monitoring of a wearing of components of the elevator system, such as wearing of sliding guide shoes and rails, on the basis of the tilting, and especially on the basis of a development of the tilting during the use of the elevator system.

The specific examples provided in the description given above should not be construed as limiting the applicability and/or the interpretation of the appended claims. Lists and groups of examples provided in the description given above are not exhaustive unless otherwise explicitly stated.

1. A method for evaluating an orientation of an elevator car, the method, performed by a control unit comprising the steps of:
obtaining measurement data from at least one inclination sensor associated to the elevator car, the measurement data comprising data values indicative of an orientation of the elevator car;
comparing the data values of the measurement data to reference data values; and
setting, in accordance with the comparison between the data values of the measurement data to the reference data values, a detection result to express one of the following:
i) the orientation of the elevator car proper; and
ii) the orientation of the elevator car is improper.

2. The method of claim 1, wherein the reference data values are generated computationally by one of:
obtaining the measurement data from the at least one inclination sensor in response to a detection that the elevator car is empty and an indication of an allowable take-off of the elevator car is generated; and
obtaining the measurement data from the at least one inclination sensor in response to a detection that the elevator car is empty and the elevator car travels at a constant speed.

3. The method of claim 1, wherein the reference data values are defined in accordance with a temperature in an operation environment of the at least one inclination sensor.

4. The method of claim 3, further comprising the steps of:
obtaining data indicative of an operating temperature of the accelerometer;
generating an inquiry to data storage for obtaining the reference data values corresponding to the operating temperature of the inclination sensor, the inquiry comprising data indicative of the operating temperature of the inclination sensor; and
applying the inquired reference data values in the step of comparing.

5. The method of claim 1, wherein the step of comparing comprises:
detecting if at least one data value of the measurement data deviates from a respective reference data value over a predefined limit.

6. The method of claim 1, wherein the measurement data is obtained from the at least one inclination sensor at least at one of the following instants of time:
an indication of an allowable take-off of the elevator car is generated; and
a detection of a constant speed of the elevator car is generated.

7. The method of claim 1, further comprising the step of, in response to the step of setting the detection result to correspond that the orientation of the elevator car is improper, generating a control signal to cause at least one of the following:
outputting an indication;
a prevention of a travel of the elevator car;
a braking of a motion of the elevator car;
a generation of a request to re-distribute a load in the elevator car; and
a generation an alarm signal to a pre-defined destination.

8. The method of claim 1, wherein the inclination sensor is an accelerometer.

9. An arrangement for evaluating an orientation of an elevator car, the arrangement comprising:
at least one inclination sensor associated to the elevator car of an elevator system; and
a control unit configured to:
obtain measurement data from the at least one inclination sensor associated to the elevator car, the measurement data comprising data values indicative of an orientation of the elevator car;
compare the data values of the measurement data to reference data values; and
set, in accordance with the comparison between the data values of the measurement data to the reference data values, a detection result to express one of the following:
i) the orientation of the elevator car is proper; and
ii) the orientation of the elevator car is improper.

10. The arrangement of claim 9, wherein the control unit is arranged to generate computationally the reference data values by one of:
obtaining the measurement data from the at least one inclination sensor in response to a detection that the elevator car is empty and an indication of an allowable take-off of the elevator car is generated; and
obtaining the measurement data from the at least one inclination sensor in response to a detection that the elevator car is empty and the elevator car travels at a constant speed.

11. The arrangement of claim 9, wherein the control unit is arranged to define the reference data values in accordance with a temperature in an operation environment of the at least one inclination sensor.

12. The arrangement of claim 11, wherein the control unit is further configured to:
obtain data indicative of an operating temperature of the inclination sensor;
generate an inquiry to data storage for obtaining the reference data values corresponding to the operating temperature of the inclination sensor, the inquiry comprising data indicative of the operating temperature of the inclination sensor; and
apply the inquired reference data values in the comparison.

13. The arrangement of claim 9, wherein the control unit is configured to perform the comparison by:
detecting if at least one data value of the measurement data deviates from a respective reference data value over a predefined limit.

14. The arrangement of claim 9, wherein the control unit is configured to obtain the measurement data from the at least one inclination sensor at least at one of the following instants of time:
an indication of an allowable take-off of the elevator car is generated; and
a detection of a constant speed of the elevator car is generated.

15. The arrangement of claim 9, wherein the control unit is further configured to, in response to setting of the detection result to correspond that the orientation of the elevator car is improper, generate a control signal to cause at least one of the following:
outputting an indication;
a prevention of a travel of the elevator car;
a braking of a motion of the elevator car;
a generation of a request to re-distribute a load in the elevator car; and
a generation an alarm signal to a pre-defined destination.

16. The arrangement of claim 9, wherein the inclination sensor is an accelerometer.

17. The arrangement of claim 9, wherein the arrangement is implemented as an apparatus comprising the control unit and the at least one inclination sensor.

18. An elevator system comprising:
an elevator car; and
the arrangement according to claim 9.

19. A computer program product embodied on a non-transitory computer readable medium for evaluating an orientation of an elevator car, which, when executed by at least one processor, causes a control unit to perform the method according to claim 1.

20. The method of claim 2, wherein the reference data values are defined in accordance with a temperature in an operation environment of the at least one inclination sensor.
